(19) United States
(12) Patent Application Publication
(10) Pub. No.: US 2013/0177138 A1
(43) Pub. Date: Jul. 11, 2013

(54) X-RAY WAVEGUIDE

(71) Applicants: Atsushi Komoto, Moriya-shi (JP); Kohei Okamoto, Yokohama-shi (JP); Hirokatsu Miyata, Hadano-shi (JP)

(72) Inventors: Atsushi Komoto, Moriya-shi (JP); Kohei Okamoto, Yokohama-shi (JP); Hirokatsu Miyata, Hadano-shi (JP)

(73) Assignee: CANON KABUSHIKI KAISHA, Tokyo (JP)

(21) Appl. No.: 13/824,650

(22) PCT Filed: Sep. 8, 2011
(86) PCT No.: PCT/JP2011/071064

§ 371 Date: Mar. 18, 2013

(30) Foreign Application Priority Data
Sep. 24, 2010 (JP) 2010-213217

(51) Int. Cl. G21K 1/06

(52) U.S. Cl. CPC G21K 1/062; G21K 2201/061
USPC 378/145

(57) ABSTRACT

An X-ray waveguide includes a core to guide X-rays in a wavelength band where the real part of the refractive index of a material is 1 or less, and a cladding to confine the X-rays to the core, in which the core includes a periodic structure having basic structures that contain materials having different real parts of refractive indices, the basic structures being periodically arranged, a low electron density layer is arranged between the core and the cladding and has a lower electron density than that of a material having the highest electron density of all the materials constituting the core, and the critical angle for total reflection of the X-rays at the boundary between the cladding and the low electron density layer is larger than the Bragg angle attributed to the periodicity of the basic structures in the periodic structure of the core.

### TECHNICAL FIELD

The present invention relates to an X-ray waveguide including a core and a cladding, in particular, to an X-ray waveguide including a core that has a periodic structure.

### BACKGROUND ART

In the case of dealing with electromagnetic waves having wavelengths of less than several tens of nanometers, a difference in refractive index for the electromagnetic waves between different materials is as very small; hence, the critical angle for total reflection is also very small. To control the electromagnetic waves including X-rays, large-scale spatial optical systems have been used and are still mainly used. As a main component included in large-scale spatial optical systems, there is a multilayer reflector in which layers of materials having different refractive indices are alternately stacked. The multilayer reflector is responsible for beam shaping, spot-size conversion, wavelength selection.

Unlike such large-scale spatial optical systems mainly used, known X-ray waveguides, such as polycapillaries, confine X-rays therein and propagate the X-rays. To miniaturize optical systems and improve performance, studies on X-ray waveguides in which electromagnetic waves are confined to thin films or multilayer films and propagated have recently been conducted. Specifically, a study on a thin-film waveguide in which a guiding layer is sandwiched between two layers having a one-dimensional periodic structure is conducted (see NPL 2). Furthermore, a study on an X-ray waveguide in which a plurality of thin-film X-ray waveguides configured to confine X-rays owing to total reflection are located adjacent to each other is conducted (see NPL 1).

### CITATION LIST

### Non Patent Literature

NPL 1 Physical Review B, Volume 62, Issue 24, p. 16939 (2000-II)
NPL 2 Physical Review B, Volume 67, Issue 23, p. 233303 (2003)

### SUMMARY OF INVENTION

### Technical Problem

However, the foregoing reports have problems to be improved. In NPL 1, the plural thin-film waveguides are stacked. X-rays are confined to each of the thin-film waveguides owing to total reflection. So, Ni, which has a small real part of the refractive index and a large imaginary part of the refractive index, is used as a cladding material for each thin-film waveguide, thus increasing the propagation loss of X-rays in the claddings. Furthermore, waveguide mode coupling between adjacent thin-film waveguides occurs. As a result, many coupled modes are formed as the entirety of the waveguide, thus causing difficulty in exciting a single waveguide mode.

Meanwhile, NPL 2 discloses an X-ray waveguide configured to confine X-rays to a core using Bragg reflection in a multilayer film serving as a cladding. The multilayer film contains Ni and C. A metal material with high absorption is used for many layers, thus increasing the propagation loss of X-rays in the multilayer film. Furthermore, in order to confine X-rays to the core using Bragg reflection in the multilayer film as described above, a multilayer film having an enormous number of layers should be used as the cladding.

The present invention has been made in light of the circumstances described above. Aspects of the present invention provide an X-ray waveguide capable of producing a waveguide mode with low X-ray propagation loss and adjusting X-ray propagation loss.

### Solution to Problem

An X-ray waveguide includes a core configured to guide X-rays in a wavelength band where the real part of the refractive index of a material is 1 or less, and a cladding configured to confine the X-rays to the core, in which the core includes a periodic structure having a plurality of basic structures that contain a plurality of materials having different real parts of refractive indices, the basic structures being periodically arranged, a low electron density layer is arranged between the core and the cladding and has a lower electron density than that of a material having the highest electron density of all the plural materials constituting the core, and the critical angle for total reflection of the X-rays at the boundary between the cladding and the low electron density layer is larger than the Bragg angle attributed to the periodicity of the basic structures in the periodic structure of the core.

### Advantageous Effects of Invention

An X-ray waveguide according to aspects of the present invention is capable of achieving a waveguide mode with low propagation loss and adjusting X-ray propagation loss.

### BRIEF DESCRIPTION OF DRAWINGS

FIG. 1 is a schematic drawing of an X-ray waveguide according to an embodiment of the present invention.

FIG. 2 is an explanatory drawing of X-ray electric field intensity distribution in a periodic structure.

FIGS. 3A and 3B illustrate X-ray electric field intensity distribution and the dependence of propagation loss on the number of periods, respectively.

FIGS. 4A to 4C illustrate the change of electric intensity distribution due to a low electron density layer.

FIGS. 5A and 5B illustrate X-ray transmittance and the selective transmittance of a waveguide mode.

### DESCRIPTION OF EMBODIMENTS

Embodiments of the present invention will be described in detail below.

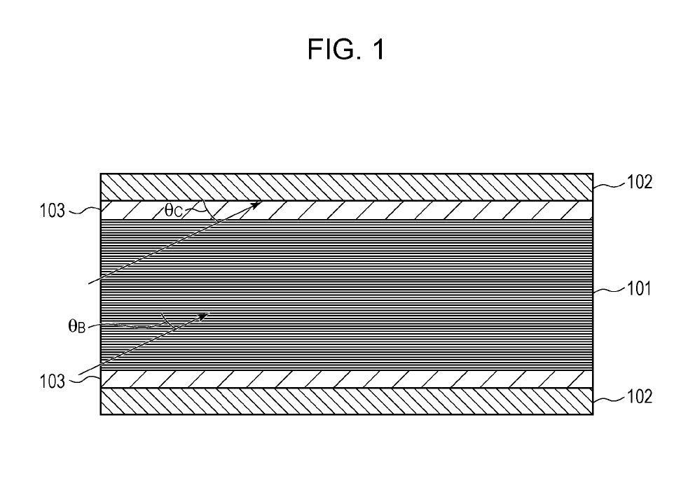

FIG. 1 is a schematic drawing of an X-ray waveguide according to an embodiment of the present invention. The X-ray waveguide according to an embodiment of the present invention includes a core 101 configured to guide X-rays in a wavelength band where the real part of the refractive index of a material is 1 or less; and claddings 102 configured to confine X-rays to the core. The core 101 includes a periodic structure in which a plurality of basic structures containing a plurality of materials having different real parts of the refractive indices are periodically arranged. Furthermore, low electron density layers 103 containing a material having a lower electron density than that of a material having the highest electron density of all the plural materials constituting the core is arranged between the core 101 and each of the claddings 102. The critical angle θ_{C} for total reflection of X-rays at boundaries between the claddings and the low electron density layers is larger than the Bragg angle θ_{B} attributed to the periodicity of the basic structures in the periodic structure of the core.

The X-ray waveguide according to aspects of the present invention is an X-ray waveguide that can use a waveguide mode attributed to the periodicity of the periodic structure of the core 101. The arrangement of the low electron density layers 103 at the boundaries between the claddings 102 and the core 101 enables us to adjust the X-ray electric field distribution and the propagation loss of the waveguide mode. An appropriate adjustment of the thickness of each of the low electron density layers 103 makes it possible to change the propagation loss of the waveguide mode attributed to the periodicity of the periodic structure (core 101).

### X-Rays

In aspects of the present invention, X-rays indicate electromagnetic waves in a wavelength band in which the real part of the refractive index of a material is 1 or less. Specifically, X-rays according to aspects of the present invention indicate electromagnetic waves having wavelengths of 100 nm or less and including extreme-ultraviolet (EUV) light. Such short-wavelength electromagnetic waves have very high frequencies. So, electrons in the outermost shells of materials cannot respond. Thus, such short-wavelength electromagnetic waves differ from the frequency band of electromagnetic waves, such as visible light and infrared rays, having wavelengths equal to or longer than wavelengths of ultraviolet light. It is known that real parts of the refractive indices of materials are less than 1 for X-rays. The refractive index n of a material for X-rays is commonly represented by expression (1):

[Math. 1]

n=1−δ−i\tilde{β}=ñ−i\tilde{β} expression (1)

where δ in the real part indicates the amount of shift from 1, and

[Math. 2]

\tilde{β}

in the imaginary part relates to absorption. Except in the case where the intrinsic energy absorption edge of an atom contributes, in general, δ is proportional to the electron density ρₑ of a material. So, a material having a higher electron density has a smaller real part of the refractive index. The real part of the refractive index is represented by:

[Math. 3]

ñ=1−δ

The electron density ρₑ is proportional to an atomic density ρₐ and an atomic number Z. As described above, the refractive index of a material for X-rays is expressed as a complex number. In this specification, the real part is referred to as the “real part of the refractive index”, and the imaginary part is referred to as the “imaginary part of the refractive index”.

A material having the highest real part of the refractive index is a vacuum. In a typical environment, air has the highest real part of the refractive index of almost all materials, excluding gases. In aspects of the present invention, two or more materials having different real parts of refractive indices may also be referred to as “two or more materials having different electron densities”, in many cases.

### Relationship Between Core and Cladding

The X-ray waveguide according to according to aspects of the present invention confines X-rays to the core using total reflection at boundaries between the core and the claddings to guide X-rays. To achieve the total reflection, in the X-ray waveguide according to aspects of the present invention, the real part of the refractive index of the core is larger than the real part of the refractive index of the low electron density layers.

In aspects of the present invention, the critical angle for total reflection at the boundary between each cladding and a corresponding one of the low electron density layers is defined as an angle θ_{C} from the boundary between the cladding and the low electron density layer, as illustrated in FIG. 1.

### Core

The X-ray waveguide according to aspects of the present invention is characterized in that the core has a periodic structure containing a plurality of materials having different real parts of the refractive indices. Because of the periodic structure of the core, a waveguide mode attributed to the periodic structure is obtained in the waveguide. In the case where the number of the periods is infinite, such a periodic structure containing plural materials having different real parts of the refractive indices produces a photonic band structure specified by propagation constants and the angular frequencies of X-rays. Only X-rays in a specific mode can be present in the structure.

The periodic structure is a structure in which basic structures are periodically arranged. One- to three-dimensional periodic structures may be used. Specific examples thereof include a one-dimensional periodic structure in which layered structures serving as basic structures are stacked, a two-dimensional periodic structure in which cylindrical structures serving as basic structures are arranged, and a three-dimensional periodic structure in which cage structures serving as basic structures are arranged.

The waveguide mode formed in the X-ray waveguide according to aspects of the present invention is attributed to multiple reflections corresponding to each of the dimensions of the foregoing periodic structures. Such a waveguide mode is formed on the basis of periodicity. So, positions of nodes and antinodes in X-ray electric field distribution and X-ray electric field intensity distribution conform to positions in individual material regions constituting the basic structures. In this case, the propagation loss of a waveguide mode in which the electric field intensity of X-rays is concentrated in a low-electron-density material in the periodic structure is lower than those of other waveguide modes, thus making it possible to selectively use the waveguide mode.

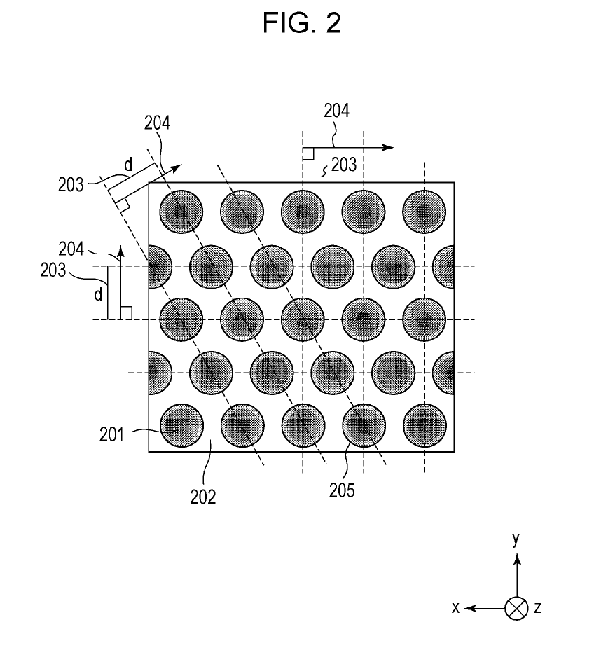

FIG. 2 is an explanatory drawing of X-ray electric field intensity distribution in a periodic structure. FIG. 2 illustrates an example of X-ray electric field intensity distribution in a periodic structure in which cylindrical air holes 201 extending in one direction in silica 202 form a two-dimensional triangular-lattice structure in a direction (direction in the xy plane) perpendicular to the longitudinal direction of the holes (z direction in the drawing). In FIG. 2, solid lines indicate structural periods d. The monochrome shading in the cylindrical air holes 201 indicates the X-ray electric field intensity and the electric field intensity distribution of one of the waveguide modes formed in the material. The propagation direction of X-rays is a direction (z direction) perpendicular to the paper plane. Black and white correspond to high electric field intensity and low electric field intensity, respectively. The central portion of each of the air holes 201 is deep black. From the central portion toward the circumferential portion of the hole, the color is gradually changed from black to white. The surrounding portion of the holes is white. The maximum and minimum electric field intensity regions are periodically repeated in the x and y directions. This demonstrates that the electric field is concentrated in the holes of the periodic structure (basic structures 205 of the periodic structure). The air holes 201 indicate the basic structures 205 of the periodic structure. Reference numeral 204 denotes directions of the periods.

### Confinement

The electric field intensity distribution attributed to the periodic structure is confined to the core with the claddings to form a waveguide mode attributed to the periodicity, thereby guiding X-rays. In the X-ray waveguide according to aspects of the present invention, in addition to the waveguide mode attributed to the periodicity, there is a waveguide mode when the entire core is regarded as a uniform medium having an average refractive index, and the waveguide mode is referred to as a uniform mode.

Unlike the uniform mode, the waveguide mode attributed to the periodicity used in the X-ray waveguide according to aspects of the present invention has a lower loss than those of adjacent modes and is in the same phase. The X-ray waveguide according to aspects of the present invention forms the waveguide mode attributed to the periodicity by total reflection at the boundaries between the claddings and the core, separately from the uniform mode. So, the X-ray waveguide is designed in such a manner that structural periods (d) 203 satisfy expression (2) described below.

The structural periods (d) 203 are defined as periods (intervals between dashed lines in FIG. 2) of the periodic structure formed in a direction (direction in the xy plane) perpendicular to the guiding direction (propagation direction, z direction), as illustrated in FIG. 2. Lengths of the structural periods vary depending on the periodic structure. Directions of the periodic structure (in the xy plane in FIG. 2, directions perpendicular to the dashed lines) are defined as the directions of the periods 204 in this specification. In the case of a two-dimensional periodic structure as illustrated in FIG. 2, the plural structural periods 203 and the plural directions of the periods 204 are present. The structural periods 203 and the directions of the periods 204 can be measured by X-ray diffraction. In particular, in the case where a core is sandwiched between two claddings (FIG. 1), the direction of the period in FIG. 1 is set so as to conform to a direction perpendicular to a propagation direction and perpendicular to boundaries between the core and the claddings.

$$\begin{matrix}[ Math . 4 ] & \\ {θ}_{C} > {θ}_{B \_ y} \approx \frac{180}{π} arcsin ( \frac{1}{{\tilde{n}}_{core }} \frac{λ}{2 d} ) & expression ( 2 )\end{matrix}$$

where θ_{C} (°) represents the critical angle of total reflection at the boundaries between the claddings and the low electron density layers, θ_{B}_{_{—}}_{y} (°) represents the Bragg angle on the basis of the structural period d in the direction of the period, λ represents an X-ray wavelength, and

[Math. 5]

ñ_{core}

represents the real part of the average refractive index of the core.

Under the condition, not only the uniform mode but also the waveguide mode attributed to the periodicity exist in the X-ray waveguide according to aspects of the present invention. The waveguide mode attributed to the periodicity is a mode modulated by a waveguide structure in which the mode formed in the periodic structure is confined to the core with the claddings on the assumption that the periodic structure is infinite. So, in the plane perpendicular to the propagation direction, nodes and antinodes, at which the maximum electric field intensity is provided in the electric field intensity distribution of the waveguide mode attributed to the periodicity, conform to the basic structures of the periodic structure.

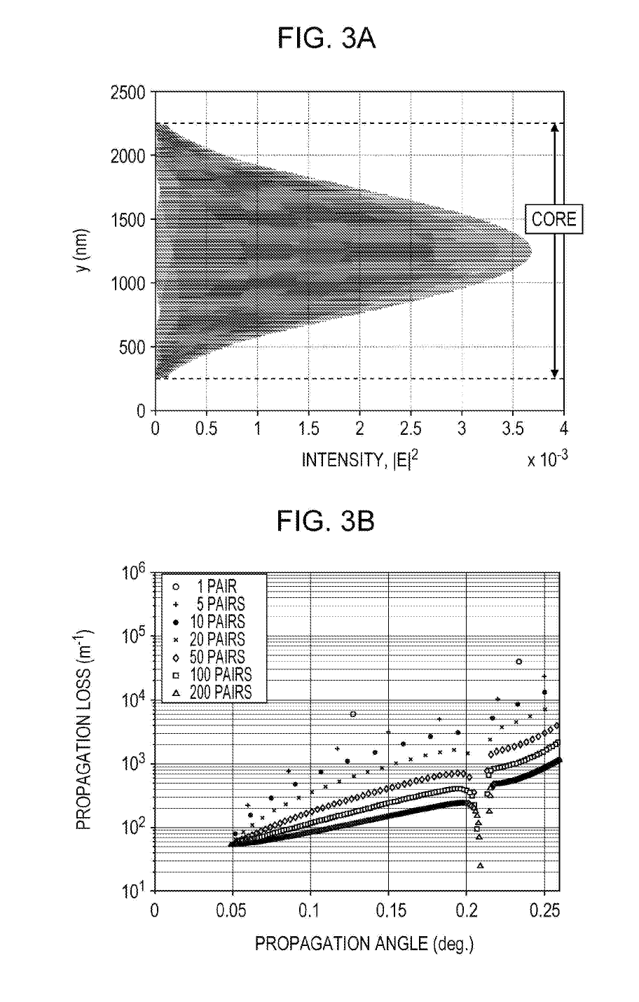

The waveguide mode attributed to the periodicity has a lower loss than that of the adjacent uniform mode, so that X-rays can be guided in a selected mode. FIGS. 3A and 3B illustrate X-ray electric field intensity distribution and the dependence of propagation loss on the number of periods, respectively. FIG. 3A illustrates a waveguide mode attributed to the periodic structure of a waveguide that includes a core having a one-dimensional periodic structure with a layered structure, serving as a basic structure, containing silica and a surfactant and a cladding containing gold. FIG. 3A also illustrates the results of a simulation experiment in the electric field intensity distribution in the core of the waveguide mode attributed to the periodic structure by a finite-element method. In the figure, E represents the electric field of X-rays, and y represents the space coordinate in a cross section of the waveguide. The propagation angle of the waveguide mode is slightly smaller than the Bragg angle of the periodic structure, achieving the waveguide mode in which the electric field is concentrated in the central portion of the core, the degree of the penetration to the cladding is low, and the phase profile is controlled. As illustrated in FIG. 3B, the waveguide mode attributed to the periodicity has the advantage that an increase in the number of periods enhances the effect to reduce the propagation loss. The number of periods of the core of the X-ray waveguide according to aspects of the present invention is preferably 20 or more and more preferably 50 or more.

A confinement structure in which X-rays are confined to a core of an X-ray waveguide according to aspects of the present invention may be a one-dimensional confinement structure in which a laminar core is sandwiched between claddings, or a two-dimensional confinement structure in which a core having a circular or rectangular cross section perpendicular to the propagation direction is surrounded by cladding. In a waveguide having a two-dimensional confinement structure, X-rays are two-dimensionally confined to the waveguide. So, an X-ray beam having a low divergence and a small beam size emerges compared with the one-dimensional confinement structure. In the case where a periodic structure has a two-dimensional structure (basic structure: cylindrical structure) or a three-dimensional structure (basic structure: cage structure), electric field intensity distribution attributed to the periodic structure in which plural directions of periods are observed is more efficiently formed in the core. That is, it is possible to provide an X-ray beam in which the phase profile is two-dimensionally controlled in a cross section of the waveguide.

### Cladding Material

At the boundaries between the claddings and the low electron density layers, the real part of the refractive index of a material constituting the claddings is set to n_{cladding}, and the real part of the refractive index of the low electron density layers is set to n_{low-e}. In this case, the critical angle θ_{C}(°) of total reflection with respect to a direction parallel to the planes of the layers is represented by the following expression:

$${θ}_{C} = \frac{180}{π} arccos ( \frac{{n}_{cladding}}{{n}_{low \text{-} e}} ) , \qquad [ Math . 6 ]$$

provided that n_{cladding}<n_{low-e}. A cladding material for the X-ray waveguide according to aspects of the present invention may be a material such that other structural parameters and physical property parameters of the waveguide satisfy expression (2). For example, in the case where the core contains mesoporous silica having a two-dimensional periodic structure in which holes are arranged at a period of 10 nm in the form of a triangular lattice in the direction of confinement and where the low electron density layers contain an organic material, such as a polymer, the claddings may contain, for example, Au, W, or Ta.

The X-ray waveguide having such a structure according to aspects of the present invention guides X-rays in a low-loss waveguide mode which is attributed to the periodicity and which has a controlled phase.

### Low Electron Density Layer, its Thickness, and Relationship Between Low Electron Density Layer and Periodic Structure

The X-ray waveguide according to aspects of the present invention is characterized in that the low electron density layers are arranged between the periodic structure serving as the core and the claddings. The low electron density layers contain a material having an electron density lower than that of a material having the highest electron density of all materials constituting the core. For example, in the case where the periodic structure contains mesoporous silica, an organic material, e.g., a surfactant or a polymer, or an inorganic material, e.g., B₄C, having an electron density lower than that of silica having the highest electron density is used as a material for the low electron density layers. The presence of the low electron density layers modulates the profile of electric field intensity distribution in a cross section of the waveguide in a waveguide mode attributed to multiple reflections in the periodic structure to appropriately adjust the propagation loss.

As described above (FIGS. 3A and 3B), in the case where the low electron density layers are not arranged, X-ray electric field intensity distribution is concentrated in the center of the core, forming a waveguide mode in which the loss due to penetration to the claddings is low, i.e., forming a waveguide mode with low propagation loss compared with those adjacent modes.

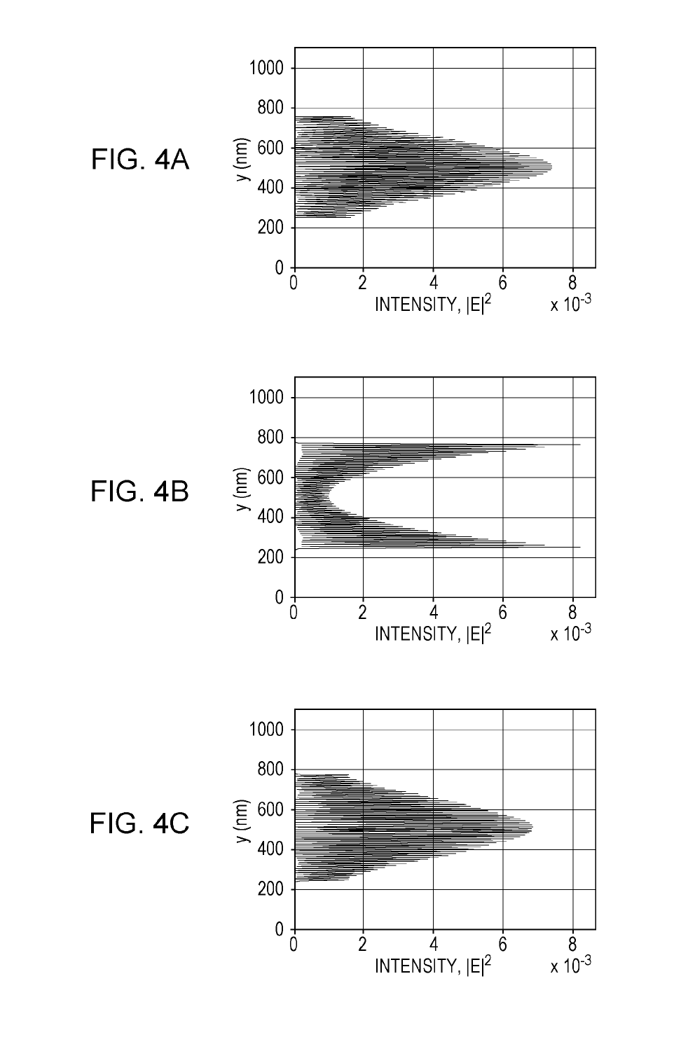

FIGS. 4A to 4C illustrate the simulation results of an X-ray waveguide by a finite-element method, the X-ray waveguide including a core having a periodic multilayer structure (structural period: 10 nm) containing silica and a surfactant and low electron density layers containing a polymer between the core and claddings. FIG. 4A illustrates the case of no low electron density layer. In the case where low electron density layers each having a thickness of 4 nm are arranged, the X-ray electric field intensity distribution of a waveguide mode is changed, compared with the case of no low electron density layer (FIG. 4A), as illustrated in FIG. 4B. While the electric field intensity distribution is concentrated in the center of the core in FIG. 4A, the electric field intensity distribution is concentrated at boundaries between the low electron density layers and the claddings to increase the degree of the penetration of X-rays to the claddings, thereby increasing the propagation loss compared with other adjacent modes. That is, this indicates that a waveguide mode attributed to the periodicity is not selectively transmitted.

Meanwhile, in the case where low electron density layers each having a thickness equal to the structural period of the periodic structure are arranged, similarly to the case of no low electron density layer, the electric field intensity is concentrated in the center of the core, so that the waveguide mode characteristic of the periodicity has low propagation loss, compared with other adjacent waveguide modes (FIG. 4C). The results of the simulation experiment demonstrate that when the thickness of each of the low electron density layers is equal to an integral multiple of the structural period of the periodic structure of the core, the waveguide mode characteristic of the periodicity has low propagation loss, compared with adjacent modes. Specifically, the thickness of each low electron density layer can be 1 to 5 times the structural period of the periodic structure.

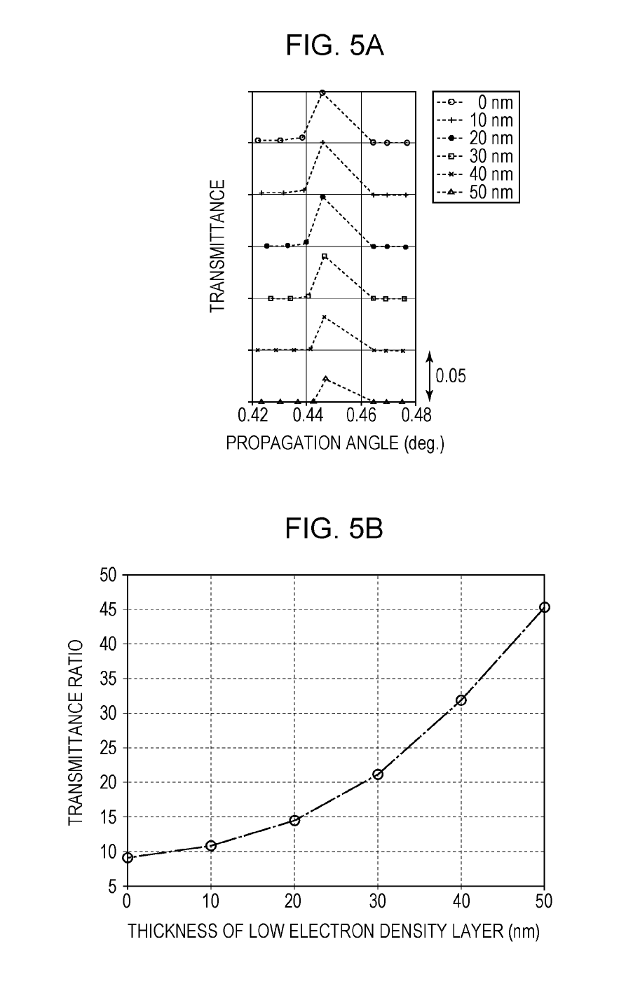

FIG. 5A illustrates guided X-ray transmittance in various modes having different propagation angles at different thicknesses of each low electron density layer. An increase in the thickness of the low electron density layer results in a reduction in the transmittance of the waveguide mode characteristic of the periodicity. However, the transmittance ratio of the waveguide mode characteristic of the periodicity to a waveguide mode having the nearest propagation angle increases with increasing thickness of the low electron density layer (FIG. 5B). This demonstrates the selective transmission of the waveguide mode attributed to multiple reflections in the periodic structure. So, the thickness of each of the low electron density layer can be appropriately selected depending on optical performance required because there is a trade-off between the selective transmission performance and the transmittance of the waveguide mode characteristic of the periodicity.

### Material for Periodic Structure

A material for a periodic structure used in the core of the X-ray waveguide according to aspects of the present invention is not particularly limited. For example, a periodic structure produced by a known semiconductor process may be used. Examples of a periodic structure that can be used include multilayer films produced by sputtering and evaporation; and periodic structures produced by photolithography, electron-beam lithography, an etching process, lamination, bonding, and so forth. The use of an oxide as a material for a periodic structure prevents oxidative degradation.

With respect to the core of the X-ray waveguide according to aspects of the present invention, the core can be formed of a mesostructured film containing an organic material and an inorganic material in view of, in particular, the simplicity of its production process and the high regularity of its periodic structure. Furthermore, the core can contain a mesoporous material.

In particular, an organic-inorganic multilayer film and a mesoporous material can be used. Porous materials are categorized on the basis of pore size by International Union of Pure and Applied Chemistry (IUPAC). Porous materials each having a pore size of 2 to 50 nm are categorized into the mesoporous material. For these materials, typically, a reaction solution serving as a precursor of an oxide is applied onto a substrate by a process, such as application, to form a periodic structure in a self-assembly manner. Thus, the periodic structure can be produced extremely simply at high throughput without using a known semiconductor process including many steps. It is difficult to produce a periodic structure having a size of several tens of nanometers by known semiconductor processes. In particular, it would be almost impossible to produce a two- or higher dimensional periodic structure.

A periodic structure is formed of an organic-inorganic multilayer film or an inorganic component and an organic component (or air holes) of a mesoporous material. An inorganic oxide can be used as the inorganic component. Examples of the inorganic oxide include silica, titanium oxide, and zirconium oxide. Examples of the organic component include amphiphilic molecules, such as surfactants, alkyl chain portions of siloxane oligomers, and alkyl chain portions of silane coupling agents. Examples of the surfactant that can be used include C₁₂H₂₅(OCH₂CH₂)₄OH, C₁₆H₃₅(OCH₂CH₂)₁₀OH, and C₁₈H₃₇(OCH₂CH₂)₁₀OH. Specific examples of the surfactant that can be used include Tween 60 (manufactured by Tokyo Chemical Industry Co., Ltd.); and Pluronic L121, Pluronic P123, Pluronic P65, and Pluronic P85 (manufactured by BASF SE). The dimension and the structural period (interplanar spacing determined by Bragg diffraction) of the periodic structure can be adjusted by appropriately selecting the inorganic component and the organic component. In the case of hydrothermal synthesis in which a precursor reaction solution is brought into contact with a substrate to form a periodic structure, Table 1 exemplifies periodic structures corresponding to organic materials used.

TABLE 1

| | Dimension of | Structural period |
|---|---|---|
| Organic material | periodic structure | (nm) |
| Pluronic L121 | one dimensional | 11.6 |
| Pluronic L123 | two dimensional | 10.4 |
| Pluronic P85 | two dimensional | 9.3 |

In the case of a mesoporous material formed by the self-assembly of a precursor reaction solution applied, an organic material is contained in pores. The organic material can be removed by a known method, for example, firing, extraction with an organic solvent, or ozone oxidation. In aspects of the present invention, the organic component may be left in the pores of the mesoporous material as long as the target performance is achieved. Removal of the organic component can provide an X-ray waveguide with lower propagation loss because of the reduction of a component that absorbs X-rays.

### Example 1

Aspects of the present invention will be described in further detail below by examples.

With respect to an X-ray waveguide according to this example, a lower cladding is formed by depositing tungsten on a Si substrate by sputtering. A core including an organic-inorganic multilayer film is formed thereon by a sol-gel method. An upper cladding is formed by sputtering. Polystyrene layers are formed as low electron density layers by application before and after the sputtering processes.

In this example, the inorganic material of a mesostructured film (organic-inorganic multilayer film) having a layered structure is silica. A method for producing the X-ray waveguide including the organic-inorganic multilayer film according to this example includes exemplary steps described below.

### (a) Formation of Cladding Layer and Polystyrene Layer

A tungsten film having a thickness of 20 nm is formed by magnetron sputtering on a Si substrate. Then a polystyrene layer is formed by spin coating.

### (b) Preparation of Precursor Solution of Mesostructured Film

A mesostructured silica film having a layered structure is prepared by dip coating. A precursor solution of the mesostructure is prepared by stirring a solution containing tetraethoxysilane, ethanol, and 0.01 M hydrochloric acid for 20 minutes, adding an ethanol solution of a block polymer to the foregoing solution, and stirring the mixed solution for 3 hours.

As the block polymer, ethylene oxide (20)-propylene oxide (70)-ethylene oxide (20) (hereinafter, referred to as “EO (20)-PO (70)-EO (20)”) is used, numbers in parentheses indicating the number of repetitions of the corresponding block.

Methanol, propanol, 1,4-dioxane, tetrahydrofuran, or acetonitrile may be used in place of ethanol. The mixing ratio (molar ratio) of tetraethoxysilane to hydrochloric acid to ethanol to block polymer to ethanol is 1.0:0.0011:5.2:0.026:3.5. The solution is appropriately diluted and then used in order to adjust the thickness.

### (c) Formation of Mesostructured Film

Dip coating is performed on a rinsed substrate with a dip coating apparatus at a withdrawal speed of 0.5 to 2 mms⁻¹. In this case, the temperature is set to 25° C., and the relative humidity is set to 40%. After the formation of a film, the film is held for 24 hours in a thermo-hygrostat set to a temperature of 25° C. and a relative humidity of 50%.

### (d) Evaluation of Mesostructured Film

The resulting mesostructured film is analyzed by Bragg-Brentano X-ray diffraction. The results demonstrate that the mesostructured film has a layered structure of silica and the block polymer, the layered structure having high regularity in the direction normal to a surface of the substrate and having an interplanar spacing of 10 nm. The mesostructured film has a thickness of about 500 nm.

### (e) Formation of Polystyrene Layer and Cladding Layer

After polystyrene is applied by spin coating, a tungsten film having a thickness of 4 nm is formed by magnetron sputtering.

The resulting X-ray waveguide includes the core sandwiched between the claddings, in which X-rays are confined to the core owing to total reflection at boundaries between the core and the claddings. In this structure, the relationship between the period of the multilayer film serving as the core and the real part of the refractive index of the material of the core satisfies expression (2). For 8-keV X-rays, the X-rays are confined to the core owing to total reflection at the boundaries between the core and the claddings. The confined X-rays form a waveguide mode affected by the one-dimensional periodicity of the multilayer film. The critical angle of total reflection at boundaries between the claddings and the low electron density layers is 0.53°. The Bragg angle attributed to the periodicity of the basic structures of the periodic structure of the core is 0.44°.

FIG. 4C illustrates the electric intensity distribution of the lowest waveguide mode attributed to periodicity. The number of maximum values of the electric field intensity is equal to the number of periods of the mesostructured film. The electric field intensity is maximized at the central portion of the core. The loss of the waveguide mode is low, thereby providing a highly efficient waveguide.

For this waveguide structure, in the case where the polystyrene layers are formed as the low electron density layers by, for example, spin coating before and after the processes for forming the claddings, the propagation loss (transmittance) of the waveguide mode attributed to the periodicity is changed depending on the thickness (FIGS. 5A and 5B). When the thickness of each of the low electron density layers is an integral multiple of 10 nm, a far-field diffraction pattern of X-rays transmitted from the waveguide demonstrates that the waveguide mode attributed to the periodicity is selectively transmitted.

### Example 2

With respect to an X-ray waveguide according to this example, a core is sandwiched between tungsten claddings on a Si substrate. Polyimide layers are formed as low electron density layers by application between the claddings and the core before and after the processes for forming the claddings. The claddings are formed by sputtering. The core contains a mesoporous material.

In the mesoporous material, pores filled with an organic material have a two-dimensional periodic structure in a direction (direction in the xy plane) perpendicular to the guiding direction of X-rays. The mesoporous material is mesoporous silica in which a portion excluding the pores is composed of silica. A method for producing the X-ray waveguide provided with the mesoporous silica according to this example includes steps (a) to (e) described below.

### (a) Formation of Cladding Layer and Polyimide Layer

A tungsten film having a thickness of 20 nm is formed by magnetron sputtering on the Si substrate. Then a polyimide layer is formed by spin coating.

### (b) Preparation of Precursor Solution of Mesostructured Film

A mesoporous silica film having a 2D hexagonal structure is formed by dip coating. A precursor solution of the mesostructure is prepared by stirring a solution containing tetraethoxysilane, ethanol, and 0.01 M hydrochloric acid for 20 minutes, adding an ethanol solution of a block polymer to the foregoing solution, and stirring the mixed solution for 3 hours.

As the block polymer, ethylene oxide (20)-propylene oxide (70)-ethylene oxide (20) (hereinafter, referred to as “EO (20)-PO (70)-EO (20)”) is used, numbers in parentheses indicating the number of repetitions of the corresponding block.

Methanol, propanol, 1,4-dioxane, tetrahydrofuran, or acetonitrile may be used in place of ethanol. The mixing ratio (molar ratio) of tetraethoxysilane to hydrochloric acid to ethanol to block polymer to ethanol is 1.0:0.0011:5.2:0.0096:3.5. The solution is appropriately diluted and used in order to adjust the thickness.

### (c) Formation of Mesostructured Film

Dip coating is performed on a rinsed substrate with a dip coating apparatus at a withdrawal speed of 0.5 to 2 mms⁻¹. In this case, the temperature is set to 25° C., and the relative humidity is set to 40%. After the formation of a film, the film is held for 24 hours in a thermo-hygrostat set to a temperature of 25° C. and a relative humidity of 50%.

### (d) Evaluation of Mesoporous Silica Film

The resulting mesostructured film is analyzed by Bragg-Brentano X-ray diffraction. The results demonstrate that the mesostructured film has high regularity in the direction normal to a surface of the substrate and has an interplanar spacing, i.e., a period in the confinement direction, or 10 nm. The mesostructured film has a thickness of about 480 nm.

### (e) Formation of Polyimide Layer and Cladding Layer

After polyimide is applied by spin coating, a tungsten film having a thickness of 4 nm is formed by magnetron sputtering.

The resulting X-ray waveguide has a period of 10 nm and satisfies expression (2). For 17.5-keV X-rays, the X-rays are confined to the core owing to total reflection at the boundaries between the core and the claddings. The confined X-rays form a waveguide mode affected by the two-dimensional periodicity of mesoporous silica. The critical angle of total reflection at boundaries between the claddings and the low electron density layers is 0.25°. The Bragg angle attributed to the periodicity of the basic structures of the periodic structure of the core is 0.20°.

For the structure of this X-ray waveguide, in the case where the polyimide layers are formed as the low electron density layers by, for example, spin coating before and after the processes for forming the claddings, the propagation loss (transmittance) of the waveguide mode attributed to the periodicity is changed depending on the thickness. When the thickness of each of the low electron density layers is an integral multiple of 10 nm, a far-field diffraction pattern of X-rays transmitted from the waveguide demonstrates that the waveguide mode attributed to the periodicity is selectively transmitted.

### Example 3

In an X-ray waveguide according to this example, a mesostructured zirconium oxide film having a three-dimensional periodic structure is used in place of mesoporous silica, serving as the core of the X-ray waveguide according to Example 2, having the two-dimensional periodic structure. A method for producing the X-ray waveguide includes steps (a) to (e) described below.

### (a) Formation of Cladding Layer and Polystyrene Layer

A tungsten film having a thickness of 20 nm is formed by magnetron sputtering on a Si substrate. Then a polystyrene layer is formed by spin coating.

### (b) Preparation of Precursor Solution of Mesostructured Zirconium Oxide Film

A mesostructured zirconium oxide film having a 3D cubic structure is prepared by dip coating. After a block polymer is dissolved in an ethanol solvent, zirconium(IV) chloride is added to the solution. Water is then added thereto. The resulting mixture is stirred to prepare a precursor solution. The mixing ratio (molar ratio) of zirconium(IV) chloride to block polymer to water to ethanol is 1:0.005:20:40. As the block polymer, EO (106)-PO (70)-EO (106) is used.

### (c) Formation of Mesostructured Film

Dip coating is performed on a rinsed substrate with a dip coating apparatus at a withdrawal speed of 0.5 to 2 mms⁻¹. In this case, the temperature is set to 25° C., and the relative humidity is set to 40%. After the formation of a film, the film is held for two weeks in a thermo-hygrostat set to a temperature of 25° C. and a relative humidity of 50%.

### (d) Evaluation

The resulting mesostructured film is analyzed by Bragg-Brentano X-ray diffraction. The results demonstrate that the mesostructured film has high regularity in the direction normal to a surface of the substrate and has an interplanar spacing 11 nm. The mesostructured film has a thickness of about 385 nm.

### (e) Formation of Polystyrene Layer and Cladding Layer

After polystyrene is applied by spin coating, a tungsten film having a thickness of 4 nm is formed by magnetron sputtering.

The resulting X-ray waveguide has a period of 11 nm and satisfies expression (2). For 10-keV X-rays, the X-rays are confined to the core owing to total reflection at the boundaries between the core and the claddings. The confined X-rays form a waveguide mode affected by the three-dimensional periodicity of the zirconium oxide mesostructure. The critical angle of total reflection at boundaries between the claddings and the low electron density layers is 0.41°. The Bragg angle attributed to the periodicity of the basic structures of the periodic structure of the core is 0.32°.

For the structure of this X-ray waveguide, in the case where the polystyrene layers are formed as the low electron density layers by, for example, spin coating before and after the processes for forming the claddings, the propagation loss (transmittance) of the waveguide mode attributed to the periodicity is changed depending on the thickness. When the thickness of each of the low electron density layers is an integral multiple of 11 nm, a far-field diffraction pattern of X-rays transmitted from the waveguide demonstrates that the waveguide mode attributed to the periodicity is selectively transmitted.

### Example 4

With respect to an X-ray waveguide according to this example, a lower cladding is formed by depositing tungsten on a Si substrate by sputtering. A multilayer film containing B₄C and Al₂O₃ is formed thereon by sputtering. Then an upper cladding is formed by sputtering. B₄C layers, each having a lower electron density than that of Al₂O₃, are formed as low electron density layers by sputtering before and after the formation of the multilayer film.

A method for producing the X-ray waveguide according to this example includes the following steps using sputtering.

### (a) Formation of Cladding Layer and B₄C Layer

A tungsten film having a thickness of 20 nm is formed by magnetron sputtering on a Si substrate. Then a B₄C layer is formed by magnetron sputtering.

### (b) Formation of Multilayer Film

Al₂O₃ and B₄C are alternately deposited in that order by magnetron sputtering to form a multilayer film. Each of the resulting Al₂O₃ layers has a thickness of 3.6 nm. Each of the resulting B₄C layers has a thickness of 14.4 nm. The lowermost layer and the uppermost layer of the multilayer film are composed of Al₂O₃. Here, 101 Al₂O₃ layers and 100 B₄C layers are formed.

### (c) Formation of B₄C Layer and Cladding Layer

A B₄C layer is formed by magnetron sputtering. Then a tungsten film having a thickness of 4 nm is formed by magnetron sputtering.

The resulting X-ray waveguide includes the core sandwiched between the claddings, in which X-rays are confined to the core owing to total reflection at boundaries between the core and the claddings. In this structure, the relationship between the period of the multilayer film serving as the core and the real part of the refractive index of the material of the core satisfies expression (2). For 8-keV X-rays, the X-rays are confined to the core owing to total reflection at the boundaries between the core and the claddings. The confined X-rays form a waveguide mode affected by the one-dimensional periodicity of the multilayer film. The critical angle of total reflection at boundaries between the claddings and the low electron density layers is 0.51°. The Bragg angle attributed to the periodicity of the basic structures of the periodic structure of the core is 0.20°.

For the structure of this X-ray waveguide, in the case where the polystyrene B₄C layers are formed as the low electron density layers by sputtering before and after the processes for forming the claddings, the propagation loss (transmittance) of the waveguide mode attributed to the periodicity is changed depending on the thickness. When the thickness of each of the low electron density layers is an integral multiple of 18 nm, a far-field diffraction pattern of X-rays transmitted from the waveguide demonstrates that the waveguide mode attributed to the periodicity is selectively transmitted.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-213217, filed Sep. 24, 2010, which is hereby incorporated by reference herein in its entirety.

### INDUSTRIAL APPLICABILITY

An X-ray waveguide according to aspects of the present invention provides an X-ray beam having a controlled phase profile, can adjust the optical properties, such as selectivity and transmittance, of the X-ray beam, and is thus useful for, for example, analytical techniques using X-rays.

### REFERENCE SIGNS LIST

101 core (periodic structure)
102 cladding
103 low electron density layer
201 hole
202 silica
203 structural period d
204 direction of period
205 basic structure

1. An X-ray waveguide comprising:
a core configured to guide X-rays in a wavelength band where the real part of the refractive index of a material is 1 or less; and
a cladding configured to confine the X-rays to the core,
wherein the core includes a periodic structure having a plurality of basic structures that contain a plurality of materials having different real parts of refractive indices, the basic structures being periodically arranged,
a low electron density layer is arranged between the core and the cladding and has a lower electron density than that of a material having the highest electron density of all the plural materials constituting the core, and
the critical angle for total reflection of the X-rays at the boundary between the cladding and the low electron density layer is larger than the Bragg angle attributed to the periodicity of the basic structures in the periodic structure of the core.

2. X-ray waveguide according to claim 1, wherein the thickness of the low electron density layer is equal to an integral multiple of the structural period of the periodic structure of the core.

3. X-ray waveguide according to claim 1, wherein the number of periods of the periodic structure of the core is 20 or more.

4. X-ray waveguide according to claim 1, wherein the periodic structure included in the core includes organic materials and inorganic materials, the organic materials and the inorganic materials being periodically arranged.

5. X-ray waveguide according to claim 1, wherein the core contains a mesoporous material.

6. X-ray waveguide according to claim 1, wherein at least one of the plural materials having different real parts of refractive indices is an oxide.

7. X-ray waveguide according to claim 1, wherein the thickness of the low electron density layer is 1 to 5 times the structural period of the periodic structure.
